(19) United States
(12) Patent Application Publication
(10) Pub. No.: US 2026/0346641 A1
(43) Pub. Date: Nov. 5, 2026

(54) Rim for a wheel which can be supplied with a tire

(71) Applicant: Dynamic Drives Giessen GmbH, Gießen (DE)

(72) Inventors: Andreas Papenfuss, Weimar (DE); Anton Papenfuss, Berlin (DE)

(21) Appl. No.: 19/116,312

(22) PCT Filed: Oct. 6, 2023
(86) PCT No.: PCT/EP2023/077676

§ 371 Date: Apr. 1, 2025

(30) Foreign Application Priority Data
Oct. 14, 2022 (DE) 10 2022 126 976.0

(51) Int. Cl. B60B 25/00; B60B 3/00

(52) U.S. Cl. CPC B60B 25/006; B60B 3/00

(57) ABSTRACT

The invention relates to a rim for a wheel which can be supplied with a tire, wherein the rim has a rim base and rim shoulders, the tire can be arranged in the rim base between the rim shoulders, and the wheel is in the form of a disk wheel. The invention proposes that the rim consists of at least two wheel parts which can be releasably connected together and which form the rim of the disk wheel. The wheel parts can be individually uninstalled, and at least one part of one of the rim shoulders can also be uninstalled together with the wheel part.

The invention relates to a rim for a wheel which can be supplied with a tire. Such running wheels are frequently used, for example in bicycles, E-bikes, PEDs, but also in three-wheeled or multi-wheeled vehicles which are driven by muscle power or else via an electric motor. Especially if such vehicles are also provided for higher loads or a plurality of persons, the running wheels must be robust. Frequently, it is then only very difficult for an operator to change the tire of such a vehicle, since it is embedded in the rim well and can only be moved over the rim shoulder with high expenditure of force. This is therefore time-consuming or cannot be carried out at all by some operators.

Moreover, in the case of a tire change in the case of conventional rims, the wheel must first be disassembled from the vehicle before the tire change can take place. In the case of heavier and more stable vehicles, however, this is also time-consuming and force-consuming.

If an additional device, such as a motor, a generator and/or a transmission, which is arranged in the hub, is provided on the wheel, the wheel must first be disassembled in conventional rims before the device can be disassembled and/or replaced.

The object of the invention is therefore to avoid the aforementioned disadvantages and to develop a rim in which a tire change and/or the exchange of a device arranged in the hub can take place in a rapid and simple manner without great expenditure of force. This object is achieved by the characterizing features of claim 1, which have the following particular significance.

The rim comprises at least two wheel parts which can be detachably connected to one another and which, in the assembled state, form the rim of the disc wheel, wherein the wheel parts can be disassembled individually. With the disassembly of the wheel part, at least part of one of the rim shoulders is then likewise removed. As a result, the tire can be removed more easily from the rim base, since the complete rim shoulder does not have to be overcome by the tire. The disassembly can therefore be carried out significantly more efficiently and with less force. A device arranged on the wheel hub can also be easily disassembled without having to directly remove the entire wheel from the vehicle.

In a particularly preferred embodiment, the rim is formed from two mutually identical wheel parts. This is particularly cost-effective in the production and storage and also in operation, since the disassembly of the wheel parts is thereby always identical.

It is particularly advantageous if one of the rim shoulders is completely disassembled during the disassembly of the wheel part. The tire can then be disassembled and re-assembled in a particularly simple manner, since it simply only has to be pulled off laterally from the rim base and must be newly pushed thereon again.

In a particularly preferred embodiment, the wheel parts have inner tabs and outer tabs arranged offset with respect to one another. If the wheel parts are assembled to form a rim, the inner tabs and outer tabs engage behind each other, preferably in such a way that they are arranged in an alternating manner. In this state, the inner tab of a running wheel part is arranged further inward in the radial direction of the wheel than the outer tab of the other wheel part. The two tabs are thus arranged one above the other. This produces a stable wheel which can also be used in vehicles with greater loads. The outer tabs and the inner tabs are preferably arranged close to the outer circumference of the respective wheel part. The outer tabs then advantageously form the bottom of the rim base when the wheel parts are mounted to one another. In this case, the outer contours of the outer tabs are designed in such a way that they form a surface with the outer tabs on the opposite wheel part in the assembled state, in which surface the outer tabs touch almost or completely.

Furthermore, a device which fulfills a further function can be provided on the wheel. This device is then detachably provided in a receptacle in at least one wheel part. In particular, the device can be arranged on the hub of the wheel. In particular, motors, generators and/or transmissions are suitable as a device. Such devices are to be arranged in the hub. However, it is often difficult to replace it, since then the entire wheel must be disassembled from the vehicle and the device must be removed from the hub. A simple possibility of assembling and disassembling the device is to arrange the device in a housing which has one or more projections. The receptacle then has one or more recesses, through which the projections can be guided during assembly of the device. By rotating the device or housing, the projections are then in operative connection with counter-projections on the rim, as a result of which the device can be held on the wheel. The fastening and also the disassembly function in the manner of a bayonet closure, since the device is first inserted into the rim and then rotated or rotated first and then pulled out of the rim.

In order to enable a simple fastening possibility of the wheel parts on one another and/or also of the device on one or more wheel parts, screw connections can be provided. These then fasten, for example, the wheel parts to one another or also to the device or the housing thereof on one or more wheel parts. Screw connections of this type are easy to detach and, if appropriate, also be fixed with a commercially available tool. As a result, the assembly and disassembly of the parts can be carried out in a particularly simple and rapid manner. As an alternative to a screw connection, a plug-in, latching or clip connection can also be provided. The recommended value here is a releasable connection which can also be detached from an operator, for example in the case of a breakdown and can be refastened again.

A plastic, in particular a thermoplastic fiber-reinforced plastic, is advantageous as the material for the wheel parts. This is simple in processing and nevertheless has the required strengths. Carbon fibers, for example, can be provided as fiber reinforcement. The plastic also has a low weight. The wheel parts can be produced particularly well when they can be processed in an injection molding process. Thus, the wheel parts can be produced in a particularly simple and cost-effective manner. If the material of the wheel parts is additionally still recyclable, it is particularly environmentally friendly.

Further advantages and exemplary embodiments result from the following description, the dependent claims and the drawings. In the drawings, the invention is illustrated in an exemplary embodiment.

### BRIEF DESCRIPTION OF THE DRAWINGS

FIG. 1: two wheel parts connected to one another in a front view,

FIG. 2: the wheel parts along section A-A in FIG. 1,

FIG. 3: the inside of a wheel part of FIGS. 1 and 2,

FIG. 4: the wheel parts from FIGS. 1 to 3 in a side view,

FIG. 5: the wheel parts of FIG. 4 spaced apart from one another,

FIG. 6 is a perspective view of the wheel parts of FIG. 5,

FIG. 7 shows a side view of a device according to the invention,

FIG. 8: a mounted wheel with tire and device in front view,

FIG. 9: the wheel of FIG. 8 in longitudinal section,

FIG. 10 is an exploded view of the wheel of FIGS. 8 and 9 with a wheel part.

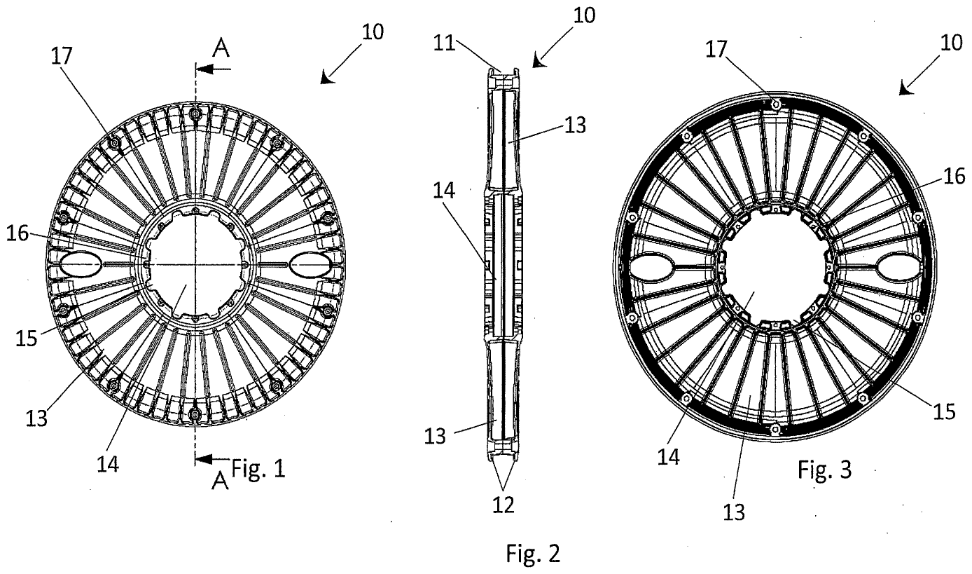

FIGS. 1 to 4 show two identical running wheel parts 13 which are fastened to one another and form a rim 10. The wheel parts 13 are arranged on one another by means of a screw connection 17 and form on their common outer circumference a rim base 11 with two rim shoulders 12. A receptacle 14 for a hub of a running wheel 30 and/or a device 20, which has a plurality of recesses 15, is provided in the center of the wheel parts 13.

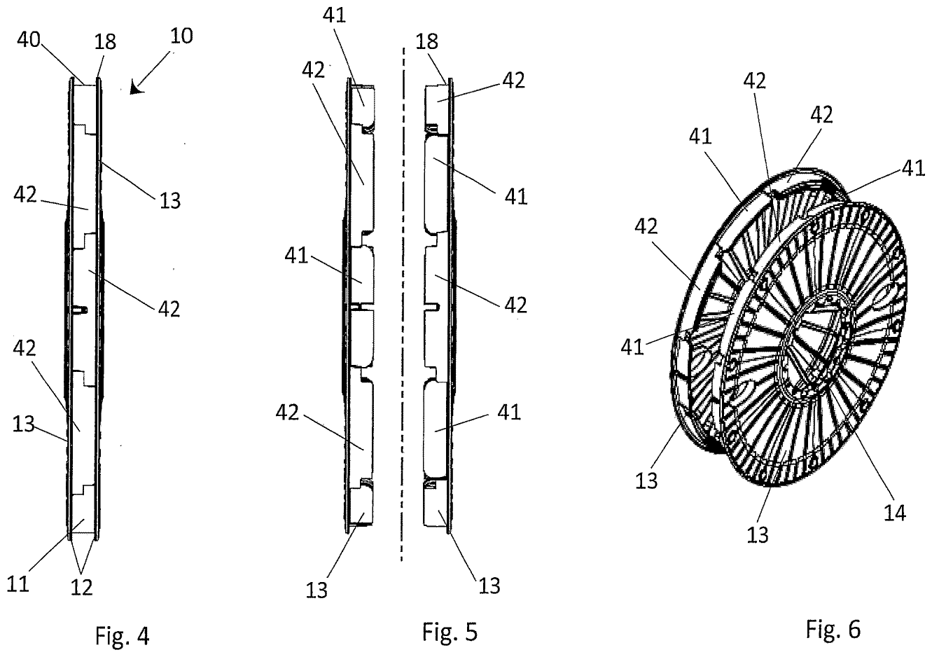

The more precise construction of the two wheel parts 13 or their interaction during assembly is shown in more detail in FIGS. 5 and 6. Near their respective outer circumference 18, the wheel parts 13 each have a plurality of inner tabs 41 and outer tabs 42. In the exemplary embodiment shown, the number of inner tabs 41 and outer tabs 42 is identical in each case. The inner tabs 41 are each arranged further inward in the radial direction than the outer tabs 42. If the two running wheel parts 13 are brought into operative connection with one another, the inner tabs 41 and outer tabs 42 are aligned with one another such that an inner tab 41 of one of the running wheel parts 13 and an outer tab 42 of the other wheel part 13 are always opposite one another. When the wheel parts 13 are then assembled to the rim 10, the inner tabs 41 are positioned below the outer tabs 42 so that they engage in a toothed manner. The outer tabs 42 then form the bottom 40 of the rim base 11, as can be seen in FIG. 4. In this case, the outer tabs 42 are shaped in such a way that they form a surface in the assembled state of the rim 10. In this case, the outer contours of the outer tabs 42 are adapted to one another in such a way that, in the assembled state of the rim 10, they almost or completely touch each other.

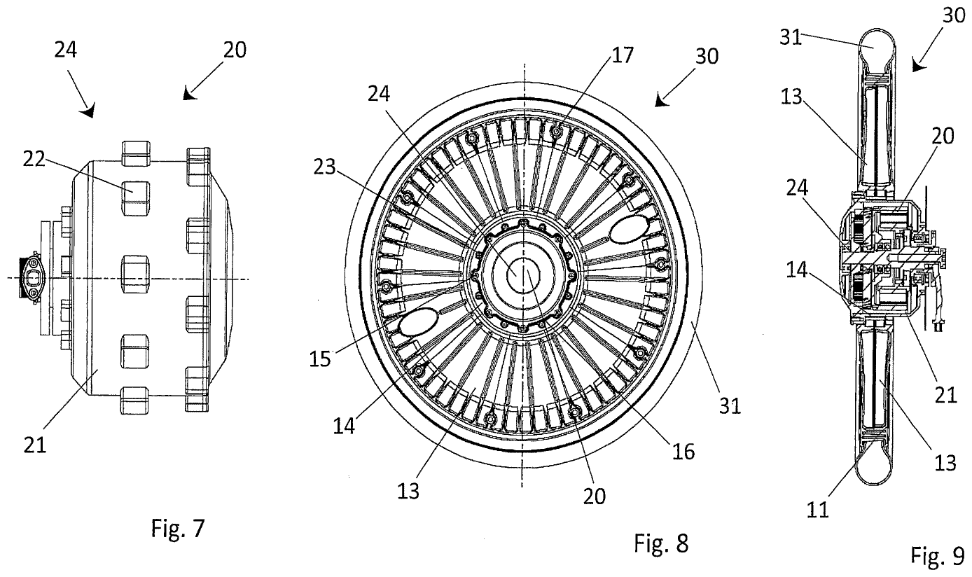

FIG. 7 shows a device 20, namely a motor 24, which can be mounted in the region of the hub of the wheel 30. A housing 21, which is provided with a plurality of projections 22, can be seen. If the motor 24 is to be arranged in the receptacle 14 of the wheel 30, it is first inserted downwards into the receptacle 14. In this case, the projections 22 can be guided through the recesses 15 in the receptacle 14. When the motor 24 has reached its axial mounting position, it is rotated slightly. As a result, the projections 22 on the housing 21 interact with the counter-projections 16 on the wheel part 13 and the motor 24 is axially held in place on the wheel 30.

This can be seen in FIGS. 8 and 9. Here, the wheel 30 is shown with two wheel parts 13, a device 20 and a tire 31. The tire is arranged in the rim well 11 between the two rim shoulders 12 on the rim 10. The device 20, which here is a motor 24, is arranged in the receptacle 14.

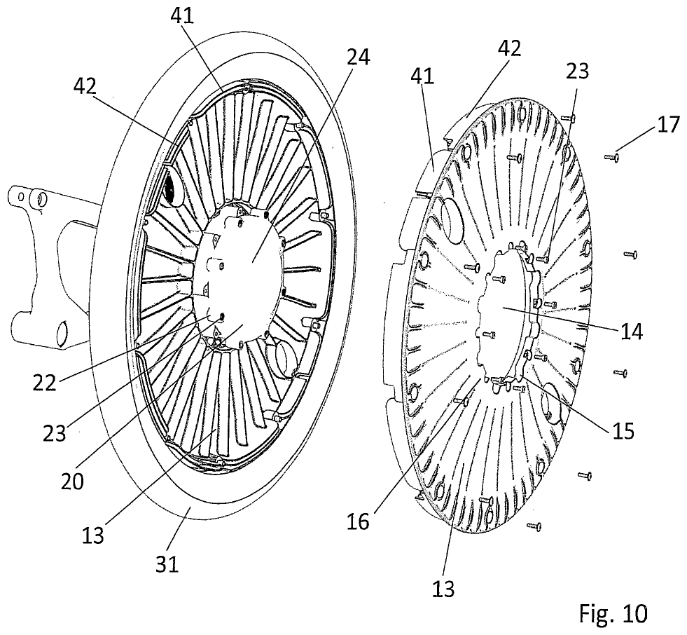

The attachment of the two wheel parts 13 to each other becomes clear in FIG. 10. Here, a plurality of screws 17 are shown, by means of which the two wheel parts are fixed to one another. If the tire 31 is now to be changed, only the screws 17 have to be released and the one wheel part 13 must be removed. Since the rim shoulder 12 is fixedly arranged on the wheel part 13, it is also removed with the wheel part 13 and the tire 31 can be pulled off the rim 10. When the new tire 31 is mounted, the wheel portion 13 can be reattached.

A plurality of screws 23 are also provided for the device 20, which screws connect the housing 21 of the device 20 to a rotor part 13 and fix it there. Thus, the device 20 can also be replaced only by the loosening of the screws 23, without the wheel 30 or a rotor part 13 having to be removed.

Finally, it should be pointed out that the embodiments illustrated here are merely exemplary implementations of the invention. This is not limited thereto. Rather, modifications and modifications are also possible.

### LIST OF REFERENCE SYMBOLS

10 Rim
11 Rim base
12 Rim shoulder
13 Wheel part
14 Receptacle
15 Recess
16 Mating projection
17 Screw connection for 13
18 Outer circumference of 13
20 Device
21 Housing
22 Projection
23 Screw connection for 20
24 Motor
30 Wheel
31 Tire
40 Bottom of 11
41 Inner tab
42 Outer tab

1. A rim (10) for a wheel (30) which can be supplied with a tire (31),
wherein the rim (10) has a rim base (11) and rim shoulders (12), wherein the tire (31) can be arranged in the rim base (11) between the rim shoulders (12)
and wherein the wheel (30) is designed as a disk wheel
characterized in that:
the rim (10) consists of at least two wheel parts (13) which can be detachably connected to one another and which form the rim (10) of the disc wheel
and that the wheel parts (13) can be disassembled individually, wherein at least part of one of the rim shoulders (12) can likewise be disassembled from the wheel part (13).

2. The rim (10) according to claim 1, characterized in that the rim (10) is formed from two mutually identical wheel parts (13).

3. The rim (10) according to claim 1, characterized in that, during the disassembly of one of the wheel parts (13), one of the rim shoulders (12) is completely disassembled.

4. The rim (10) according to claim 1, characterized in that the wheel parts (13) each have inner tabs (41) and outer tabs (42) which are arranged offset with respect to one another and which, when the wheel parts (13) are arranged on one another, engage in an alternating manner, so that the inner tab (41) of a running wheel part (13) is arranged further inside in the radial direction of the wheel (30) than the outer tab (42) of the wheel part (13) arranged opposite this wheel part (13).

5. The rim (10) according to claim 4, characterized in that the outer tabs (42) and the inner tabs (41) are arranged close to the respective outer circumference (18) of the wheel part (13).

6. The rim (10) according to claim 4, characterized in that, in the mounted state of the rim (10), the outer tabs (42) of the wheel parts (13) form the bottom (40) of the rim base (11).

7. The rim (10) according to claim 4, characterized in that the outer tabs (42) are adapted to one another from their outer contours, so that in the assembled state of the rim (10) they touch completely.

8. The rim (10) according to claim 1, characterized in that an additional device (20) is provided, which can be detachably received in a receptacle (14) in at least one of the wheel parts (13).

9. The rim (10) according to claim 8, characterized in that the device (20) has a housing (21) on which one or more projections (22) are arranged, while the receptacle (14) has one or more recesses (15) through which the projections (22) can be guided during assembly, and wherein, by rotating the device (20), the projections (22) on the housing (21) can be brought into operative connection with counter-projections (16) on the rim (10) and as a result the device (20) is held in place in the receptacle (14).

10. The rim (10) according to claim 8, characterized in that the device (20) is arranged on the hub of the wheel (30).

11. The rim (10) according to claim 8, characterized in that the device (20) is a motor (24) or a generator or a transmission.

12. The rim (10) according to claim 1, characterized in that the wheel parts (13) are fixed to one another by a screw connection (17).

13. The rim (10) according to claim 1, characterized in that the wheel parts (13) consist of plastic.

14. The rim (10) according to claim 1, characterized in that the material of the wheel parts (13) can be processed by an injection molding process.

15. The rim (10) according to claim 4, characterized in that the outer tabs (42) are adapted to one another from their outer contours, so that in the assembled state of the rim (10) they touch almost completely.

16. The rim (10) according to claim 8, characterized in that the device (20) is fixed to at least one of the wheel parts (13) by a screw connection (23).

17. The rim (10) according to claim 13, characterized in that the wheel parts (13) consist of a fiber-reinforced thermoplastic material.

18. The rim (10) according to claim 1, characterized in that the material of the wheel parts (13) can be recycled by an injection-molding process.
